(19) United States
(12) Patent Application Publication
(10) Pub. No.: US 2003/0069943 A1
(43) Pub. Date: Apr. 10, 2003

(54) Method and apparatus for user personalized and adaptive business processing modeling and integration

(75) Inventors: Peter C. Bahrs, Austin, TX (US); Brian Thomas Lillie, Austin, TX (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY

(21) Appl. No.: 09/971,218

(22) Filed: Oct. 4, 2001

(51) Int. Cl. G06F 15/16

(52) U.S. Cl. 709/219

(57) ABSTRACT

The present invention provides a method, apparatus, and computer instructions for an application server. A presentation services module uses a set of screens to receive input and presents received results. An application services module executes a set of tasks for a process using the input to obtain output data, formats the output data into a form useable by the presentation services module to form the results, and sends the results for presentation in response to the state transition.

### BACKGROUND OF THE INVENTION

1. Technical Field

The present invention relates generally to an improved data processing system, and in particular to a method and apparatus for performing a process in a data processing system in response to receiving a request. Still more particularly, the present invention provides a method and apparatus for implementing a business process in a data processing system in which changes to the business process may be made with minimal impact on applications enabling the business process.

2. Description of Related Art

The Internet, also referred to as an “internetwork”, is a set of computer networks, possibly dissimilar, joined together by means of gateways that handle data transfer and the conversion of messages from a protocol of the sending network to a protocol used by the receiving network. When capitalized, the term “Internet” refers to the collection of networks and gateways that use the TCP/IP suite of protocols.

The Internet has become a cultural fixture as a source of both information and entertainment. Many businesses are creating Internet sites as an integral part of their marketing efforts, informing consumers of the products or services offered by the business or providing other information seeking to engender brand loyalty. Further, the Internet is becoming increasingly popular as a medium for commercial transactions.

Currently, the most commonly employed method of transferring data over the Internet is to employ the World Wide Web environment, also called simply “the Web”. Other Internet resources exist for transferring information, such as File Transfer Protocol (FTP) and Gopher, but have not achieved the popularity of the Web. In the Web environment, servers and clients effect data transaction using the Hypertext Transfer Protocol (HTTP), a known protocol for handling the transfer of various data files (e.g., text, still graphic images, audio, motion video, etc.). The information in various data files is formatted for presentation to a user by a standard page description language, the Hypertext Markup Language (HTML). In addition to basic presentation formatting, HTML allows developers to specify “links” to other Web resources identified by a Uniform Resource Locator (URL). A URL is a special syntax identifier defining a communications path to specific information. Each logical block of information accessible to a client, called a “page” or a “Web page”, is identified by a URL. The URL provides a universal, consistent method for finding and accessing this information, not necessarily for the user, but mostly for the user's Web “browser”. A browser is a program capable of submitting a request for information identified by an identifier, such as, for example, a URL. A user may enter a domain name through a graphical user interface (GUI) for the browser to access a source of content. The domain name is automatically converted to the Internet Protocol (IP) address by a domain name system (DNS), which is a service that translates the symbolic name entered by the user into an IP address by looking up the domain name in a database.

The Internet also is widely used to transfer applications and to provide access to applications to users using browsers. With respect to commerce on the Web, individual consumers and businesses use the Web to purchase various goods and services. Many businesses offer services on the Web, which were once the domain of “brick and mortar” businesses. For example, services, such as banking services, loan application and processing, and car purchases are offered on the Web. Further, businesses may purchase or order goods or items solely on the Web. For example, a business may order office supplies or purchase computers on the Web. These services and the ability to purchase goods all include the use of business processes implemented in data processing systems.

The current architecture used for implementing business processes into applications for use on Web servers is unable to provide sufficient flexibility to support changes to the steps or tasks that make up a business process. Often times, it is desirable to provide an ability to dynamically alter the order of steps in a business process. Currently, the presentation of screens or Web pages to a user is closely tied to the business process. As a result, changes to the business process often require redesigning or reordering of these pages. Further, the currently available products for implementing business processes into applications are unable to provide a sufficient level of customization for different customer systems and application architectures.

Therefore, it would be advantageous to have an improved method and apparatus for implementing business processes into applications that provide the desired flexibility and customization.

### SUMMARY OF THE INVENTION

The present invention provides a method, apparatus, and computer instructions for an application server. A presentation services module uses a set of screens to receive input and presents received results. An application services module executes a set of tasks for a process using the input to obtain output data, formats the output data into a form usable by the presentation services module to form the results, and sends the results for presentation in response to the state transition.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 is a block diagram of a data processing system that may be implemented as a server in accordance with a preferred embodiment of the present invention;

FIG. 3 is a diagram illustrating an application services framework in accordance with a preferred embodiment of the present invention;

FIG. 4 is a diagram illustrating a more detailed block diagram of an application services framework in accordance with a preferred embodiment of the present invention;

FIG. 5 is a diagram illustrating state changes involved in interaction between presentation services and application services in accordance with a preferred embodiment of the present invention;

FIG. 6 is a flowchart of a process used in an application service in accordance with a preferred embodiment of the present invention;

FIG. 7 is a flowchart of a process used for executing a task is depicted in accordance with a preferred embodiment of the present invention;

FIG. 8 is a flowchart of a process used for formatting data in accordance with a preferred embodiment of the present invention;

FIG. 9 is a flowchart of a process used for modeling a business process in accordance with a preferred embodiment of the present invention;

FIG. 10 is a diagram illustrating a data structure of a business process application model in accordance with a preferred embodiment of the present invention;

FIGS. 11A and 11B are diagrams illustrating an example application service with tasks and rules are depicted in accordance with a preferred embodiment of the present invention;

FIG. 12 is a diagram illustrating classes forming a response in accordance with a preferred embodiment of the present invention; and

FIG. 13 is a diagram illustrating definition classes used during the execution of an application service in accordance with a preferred embodiment of the present invention.

### DETAILED DESCRIPTION OF THE PREFERRED EMBODIMENT

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

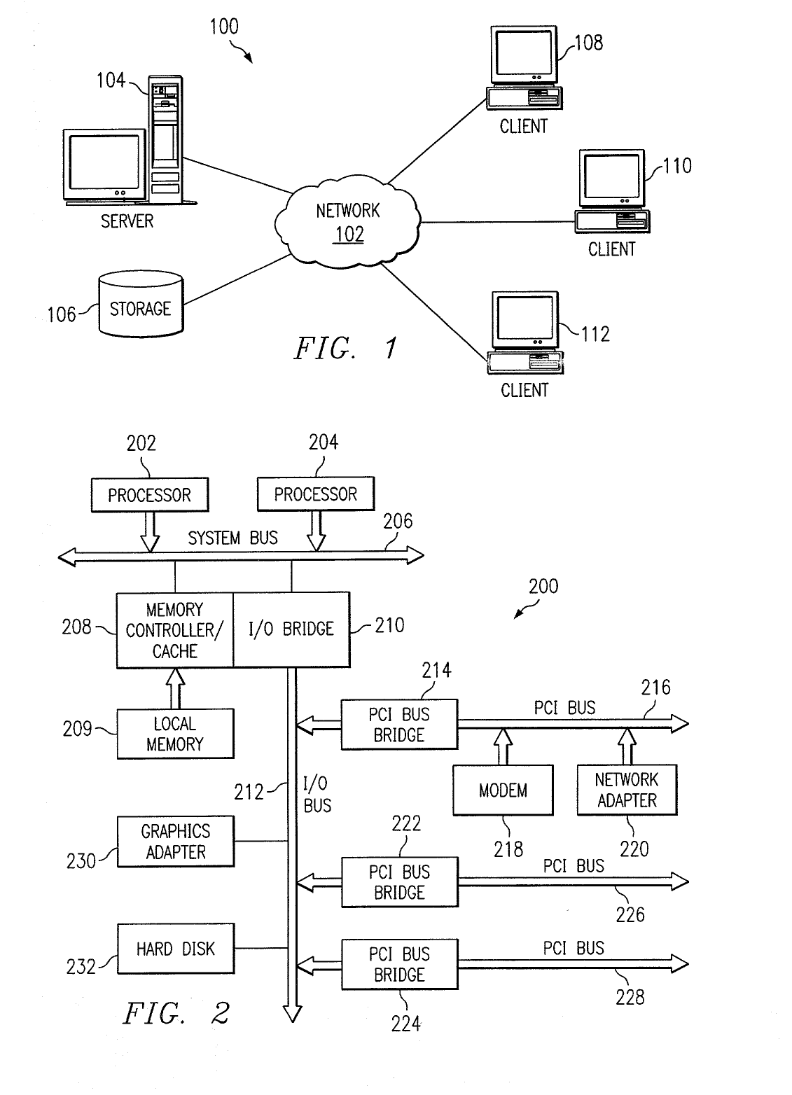

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM e-Server pSeries system, a product of International Business Machines Corporation in Armonk, N.Y., running the Advanced Interactive Executive (AIX) operating system or LINUX operating system.

A business process is a set of reusable and repeatable steps that a company or business performs for a customer. This process typically involves a user interacting with several sets of screens or Web pages within a browser. For some user interactions, calculations are performed and enterprise systems are accessed. Several sets of these interactions may be performed to complete a business process. Each interaction grouping is a task. Multiple tasks define a business process. A business or company may have numerous business processes across all lines of business.

A customer can affect the navigation through one or more business processes by following links in the browser. It is common today to support customer personalization. This type of personalization may result in a business process presenting more than one set of tasks and screens to various customers. In addition, the business process tasks may change as a result of the calculations performed by the enterprise system.

The present invention provides an improved architecture for modeling and implementing business processes within applications. This architecture is also referred to as an application services framework. This framework allows a business to make changes to business processes while minimizing the impact on the application that enables these processes.

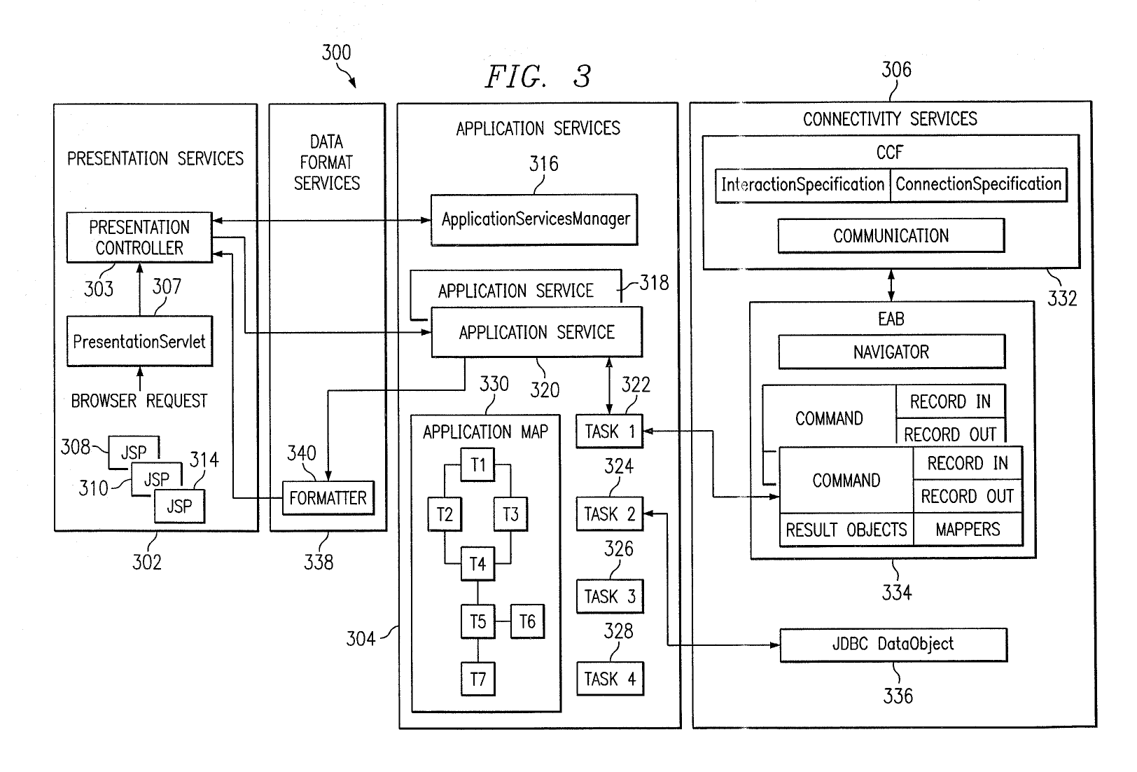

Turning next to FIG. 3, a diagram illustrating an application services framework is depicted in accordance with a preferred embodiment of the present invention. Application services framework 300 is an example of an architecture that may be implemented in a data processing system, such as data processing system 200 in FIG. 2, to offer services or goods to customers on the Web.

Application services framework 300 provides the building blocks to model business processes. This framework includes presentation services 302, application services 304, and connectivity services 306. Application services 304 separates programs using the business process, such as presentation services 302, from fulfillment of the business process, such as connectivity services 306. In other words, application services 304 separates the process from the organization that performs the work and the domain in which the work is performed.

Application services 304 implementation controls the flow of the business process by navigating through its tasks and returning indications to presentation services 302 as to which group of screens to flow through. Thus, application services 304 pushes screen hints to presentation services 302 while deciding which business tiers connectivity services 306 to communicate with and what logic to perform on the results through task navigation.

In this example, presentation services 302 includes presentation controller 303, presentation servlet 307, and Java server pages (JSPs) 308, 310, and 314. A JSP is an HTML page with embedded Java source code that is executed in the Web server or application server. The HTML provides the page layout that will be returned to the Web browser, and the Java provides the processing; for example, to deliver a query to the database and fill in the blank fields with the results. The JSP is compiled into bytecode (into a servlet) when first encountered by the server. Presentation servlet 307 creates a presentation controller, such as presentation controller 303 in response to a request from a user. Presentation controller 303 controls the presentation of screens or pages to a user using JSPs 308, 310, and 314. Of course, other mechanisms other than JSPs may be used depending on the particular implementation. For example, active server pages (ASPs) may be used in place of JSPs. In addition, presentation controller 303 sends input data gathered from the various screens to application services 304 and receives output data from application services 304 for return to the user. Application services 304 includes application services manager 316, application service 318, application service 320, task 322, task 324, task 326, task 328, and application map 330. Application services manager 316 serves to provide application services, such as application service 318 and application service 320, in response to a request from presentation controller 303 to initiate a business process. Each of these application services provides a particular business process. Each application service is essentially a business process state machine and is defined in terms of states, tasks, actions, rules, and transitions. Tasks equate to steps in a business process.

Application map 330 contains a map containing the actions, rules, and transitions between different tasks. Application map 330 defines the order in which different tasks are executed depending on the input data received from presentation services 302 or the response received from connectivity services 306.

Application service 320 will execute various tasks, such as tasks 322, 324, 326, and 328. These tasks generate commands to connectivity services 306 to obtain a response containing output data. These tasks may be used in more than one application service. For example, application service 318 may use some of the same tasks as employed in application service 320. For example, both services may use the same tasks for verifying the identification of a user.

Connectivity services 306 includes common connector framework (CCF) 332, enterprise access builder (EAB) 334, and Java database connectivity (JDBC) 336. CCF is a programming interface that lets Java applications access enterprise services using a common programming interface based on interaction specifications, connection specifications, navigators, commands, and records. EAB is the VisualAge for Java tool used to create such interaction specifications, connection specifications, navigators, commands, and records. JDBC is a programming interface that lets Java applications access a database via the SQL language. Of course, other types of services or databases may be provided through connectivity services 306 depending on the particular implementation.

Presentation servlet 307 creates or obtains a previously created presentation controller 303. Presentation controller 303 first makes a call to application services manager 316 to obtain an instance of application service 318. In these examples, a new instance is created on every call to the application services manager. Once application service 318 has been obtained, presentation controller 303 will call application service 318 to execute the request.

In these examples, application services 304 does not generate data as input to connectivity services 306 nor does it create output data for presentation services 302. Application services 304 itself does not have a private database that it pulls data from to satisfy requests. However, application services 304 can use information contained in user defined properties to fill in missing fields in requests or responses. In this example, this data has been supplied by the application service definition creator, not by application services 304 itself. Instead, this component relays and transforms data between presentation services 302 and connectivity services 306.

Data returned from connectivity services 306 may be formatted for use by presentation services 302 using data format services 338. In particular, a formatter, such as formatter 340, is used to change the format from that provided by connectivity services 306 to one useable by presentation services 302. Formatter 340 may use a hash table or some other mapping mechanism to transform the format of the data provided by connectivity services 306 to one specified for used by presentation services 302.

The definition of the business process, that is, the tasks and rules necessary to implement the business process, is externalized from the implementation of the tasks, rules, or application service. By externalizing the processes from the actual code, application services 304 makes business processes easier to change, manage, and understand. In the initial implementation, the business application model is encoded in a data structure that is stored in extensible markup language (XML).

In these examples, a business process is implemented as an application service. An application service may also be used to implement non-business process flows such as logon support. The business process is directed by both presentation services 302 (defined in terms of groups of screens) and application services 304 (defined in terms of task state).

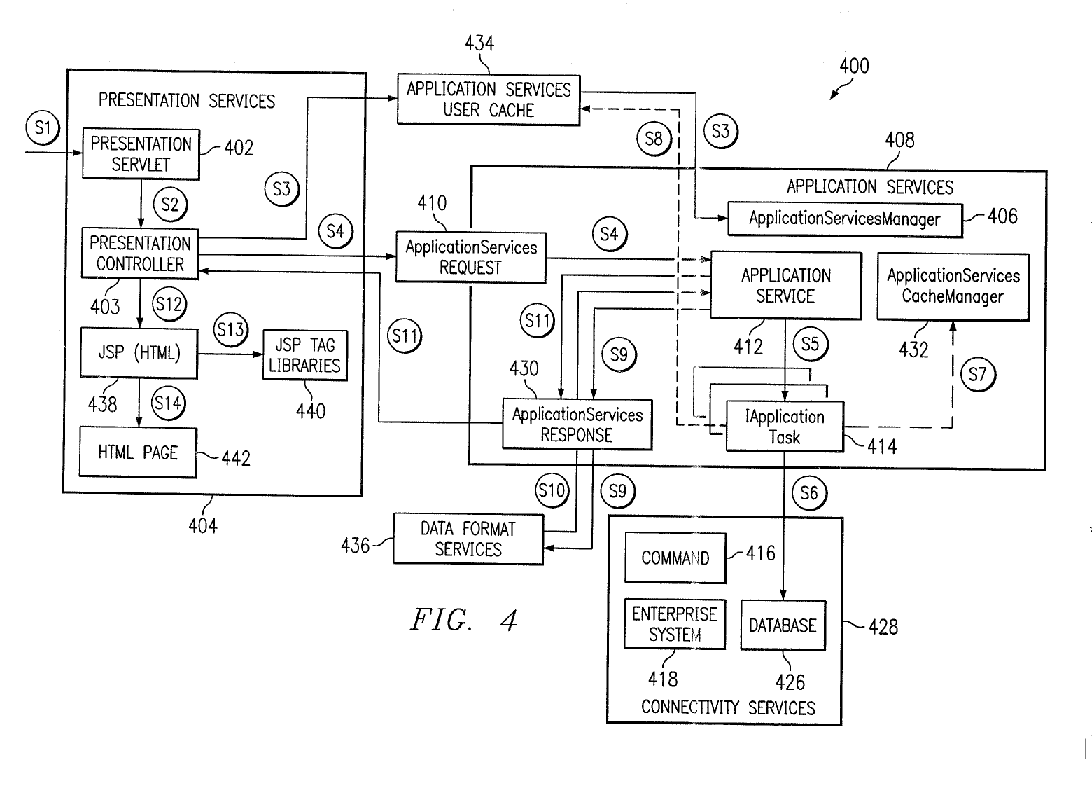

With reference next to FIG. 4, a diagram illustrating a more detailed block diagram of an application services framework is depicted in accordance with a preferred embodiment of the present invention. In this example, application services framework 400 is a more detailed illustration of application services framework 300 in FIG. 3 and illustrates control flow for an example request. In this example, a user makes a request for a new application by selecting a link in a browser and sending a URL to presentation servlet 402 in presentation services 404 (step S1). In response, presentation servlet 402 creates (or obtains a previously created) presentation controller 403 (step S2). Thereafter, presentation controller 403 requests a specific application service from application services manager 406 in application services 408 (step S3). Application services manager 406 will return a new instance on every request. The presentation controller is the sole owner of that instance. Presentation controller 403 then creates application services request 410, populates this request, and calls an execute method on application service 412 (step S4).

Application service 412 obtains an action from application services request 410. A task defined for the action is identified and a task, such as task 414, is created (step S5). Task 414 issues one or more commands, such as command 416, against enterprise system 418 or database 426 in connectivity services 428 (step S6). In response, data is returned in application services response object 430 provided by application service 412. Task 414 calls application services cache manager 432 if data is to be saved or retrieved for global use (step S7). Application services user cache 434 is called by tasks 414 if data is to be saved or retrieved for a particular user or customer (step S8).

Thereafter, application service 412 calls data format services 436 to format the data (step S9). In response, data format services 436 manipulates the data in application services response object 430 to conform to a selected data format and returns this object to application service 412 (step S10). Application service 412 returns application services response object 430 to presentation controller 403 (step S11). Presentation controller 403 may perform additional processing on the data and make it available to the JSP page. Presentation controller 403 then identifies a JSP page, such as JSP 438, for return (step S12). JSP 438 executes JSP code, including invoking custom tag libraries 440 to access the data made available by the presentation controller 403 following step S11, to generate an HTML page (step S13). Then, an HTML page, such as HTML page 442 is returned to the user (step S14).

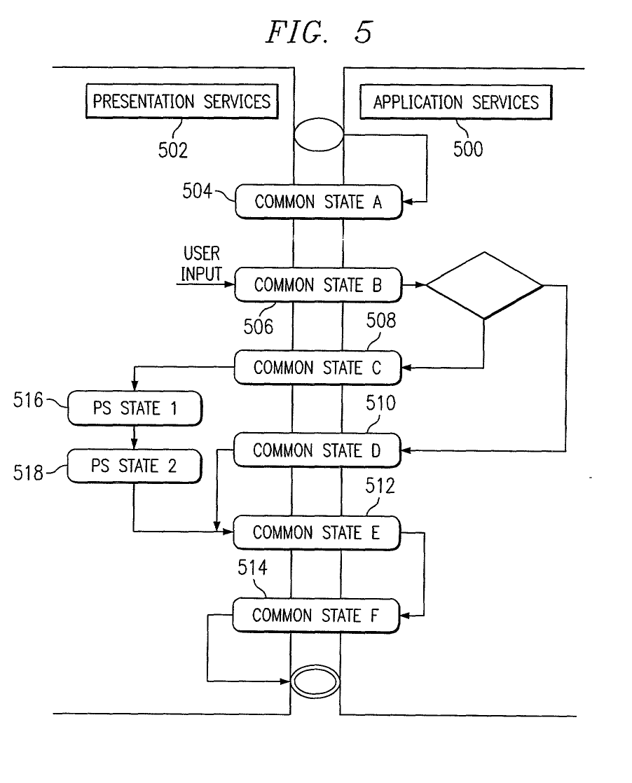

Turning next to FIG. 5, a diagram illustrating state changes involved in interaction between presentation services and application services is depicted in accordance with a preferred embodiment of the present invention.

In these examples, the design of the application services 500 is strongly tied and related to the design presentation services 502. The state definition within application services 500 is configured to correspond to a similar state within presentation services 502 control file. While application services 500 is strongly oriented to the interaction with enterprise systems, this component still provides some elements of program control that are reflected to presentation services 502.

Both presentation services 502 and application services 500 maintain their own notion of business process state and execution rules. Together, they are used to transition between states. The combined state of presentation services 502 and application services 500 makes up a larger state machine sharing the ownership of the transition rules. For some states, presentation services 502 determines the rules to follow (generally a set of Web pages to step through) in order to reach the next state. For other states, application services 500 determines the next state and returns that information to presentation services 502. Both services may use decision rules to select one of multiple possible destinations. The particular decision rules depend on the particular business process being implemented and on the particular programmer.

In addition to presentation services 502 and application services 500 determining the next state, a user may select a specific task or direct the application towards a specific state. For example, a user may be presented with different types of banking services and select a particular one, such as a loan process.

In this example, states 504, 506, 508, 510, 512, and 514 are common states between presentation services 502 and application services 500. State 516 and state 518 are private states, which correspond to flows between different pages or screens. State 504 is the first state that is present and may be transitioned into state 506 by a user input selecting a particular business process or service. At that point, a transition to state 508 and state 510 may occur based on rules defined in application services 500. These transitions are largely based upon output data received from a backend service, such as connectivity services 428 in FIG. 4. Although most state transitions occur after executing a particular task or section of logic, some transitions, such as those into state 514 may occur without any decision making. Transitions into different states may result in different types of pages being presented to a user or customer.

Still referring to FIG. 5, in this particular example, the process for an application begins in state 504, and no transition occurs unless a user input is received to select a specific state, such as state 506, in this example. Once the task defined for state 506 is executed, some decision rules applied by the application services 500 select whether state 508 or state 510 is the next to be executed, and returns that information to presentation services 502. Presentation services 502 has defined rules that permit a transition from either state 508 or state 510 to state 512.

From state 508 to state 512, presentation services 502 may run through a series of pages, such as those shown in states 516 and 518. Once the task defined for state 512 is executed, application services 500 indicates the transition to state 514. Presentation services 502 has the information that it needs to conclude the application.

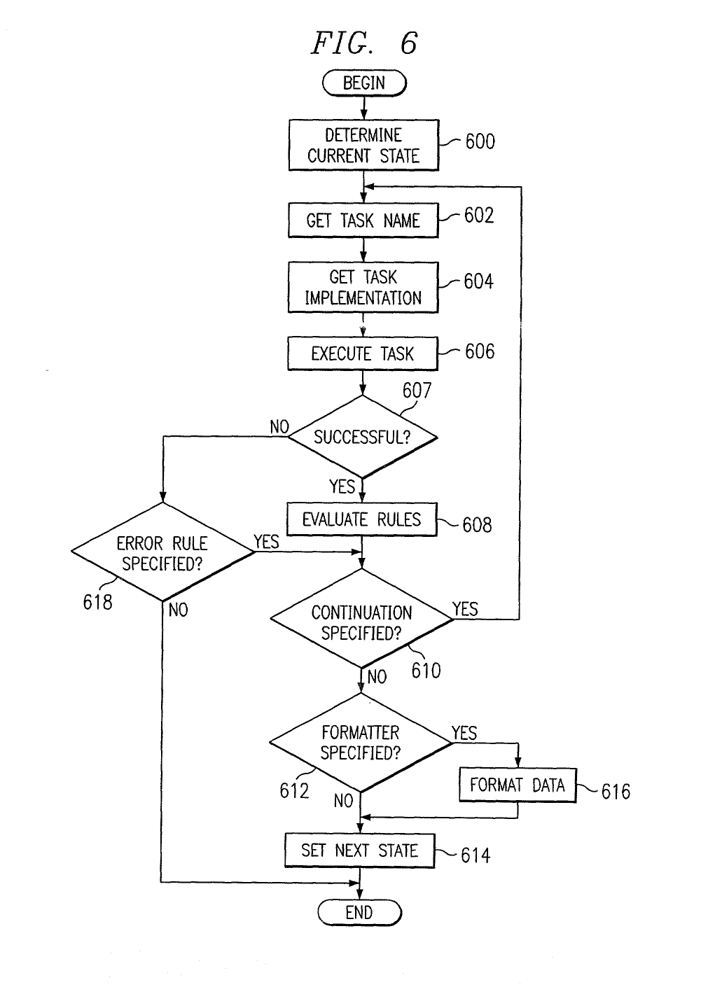

With reference now to FIG. 6, a flowchart of a process used in an application service is depicted in accordance with a preferred embodiment of the present invention. The process illustrated in FIG. 6 may be implemented in an application service, such as application service 412 in FIG. 4.

The process begins by determining the current state (step 600). A task name is retrieved (step 602). If the execution is the first execution of the application service, then the first task in the list is identified for execution in step 602. If this is not the first execution of the application service, then the task is identified either by the current state of the application service as identified in step 600 or as identified by the caller of the application service. A task implementation is retrieved (step 604). A task is a step in a generic business process. A task implementation is the actual set of instructions required to execute this business process step. This step is used to create a task. The task is then executed (step 606). Execution of step 606 results in a portion of logic being executed. This execution often results in a command or call being sent to a backend service, such as those found in connectivity services.

Next, a determination is made as to whether the task has completed successfully (step 607). If the task has successfully completed, the rules are evaluated (step 608). In step 608, rules are evaluated based on any output data returned from a backend service. The rules are evaluated in a specified order, in these examples, until a rule evaluates as true. If no rules evaluate as true, then a continuation will not be specified.

A determination is then made as to whether a continuation is specified (step 610). This step is used to determine whether additional tasks are to be executed. If another task is to be executed, then the identification of this task is typically made based on an evaluation of the rules defined for the task in step 608. If a continuation is not specified, a determination is made as to whether the formatter is specified (step 612). Step 612 is used to determine whether a formatter, such as formatter 340 in FIG. 3, is to be invoked to format the data obtained from connection services to meet a particular form required for presentation.

If the formatter is not specified, the next state is set (step 614) with the process terminating thereafter.

Returning to step 612, if the formatter is specified, the data is formatted (step 616) and the process returns to step 614 as described above. With reference again to step 610, if a continuation is specified, the process returns to step 602 as described above.

With reference again to step 607, if the task did not successfully complete, a determination is made as to whether an error rule has been specified (step 618). If the task completes unsuccessfully, and no error rule is specified, the next state would be the same as the current state and the flow will immediately proceed to end. If an error rule is specified, the process proceeds to step 610 as described above. If continuation is specified, the process returns to step 602. If no continuation rule is specified, the process proceeds to step 612.

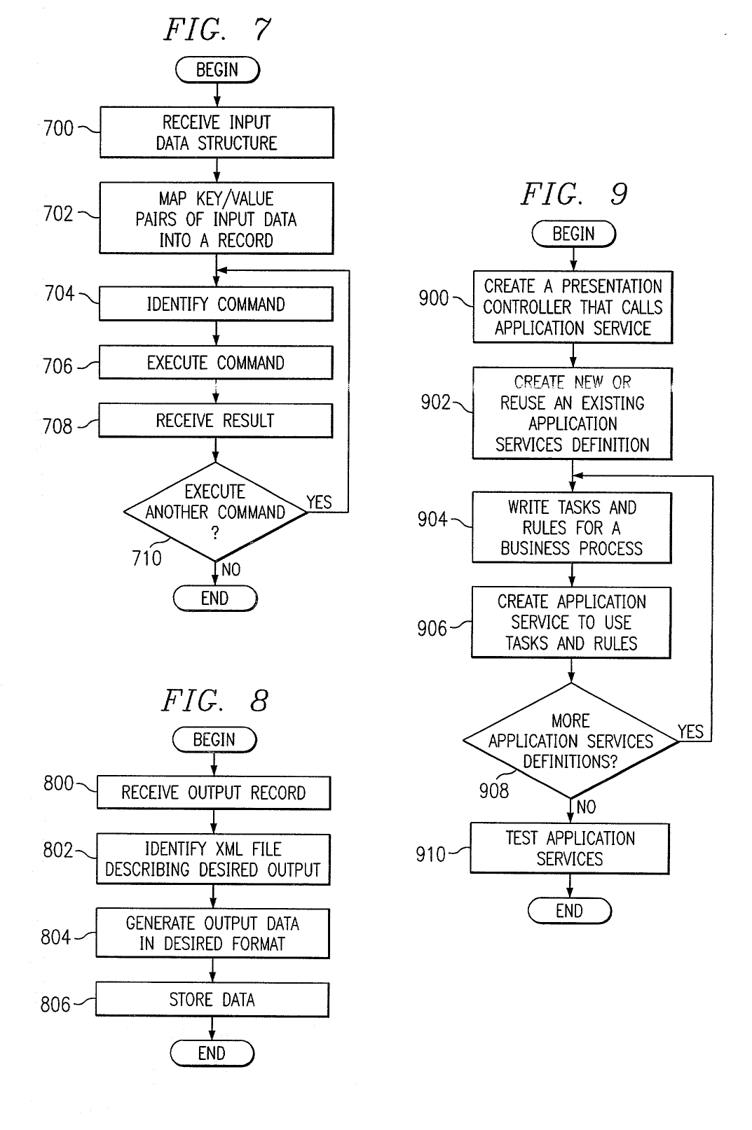

Turning next to FIG. 7, a flowchart of a process used for executing a task is depicted in accordance with a preferred embodiment of the present invention. The process illustrated in FIG. 7 may be implemented in a task, such as application task 414 in FIG. 4.

The process begins by receiving an input data structure (step 700). In these examples, the presentation services places input data into an input data structure for processing by the task. The key/value pairs of input data are mapped into a record (step 702). This input record may be used by a backend service to process a request or command from the task. Other input data may be included in the command itself. Next, a command is identified (step 704). The selection of the command in step 704 depends on the needs of a particular task. The command is typically used to obtain output data from a backend service. The command is then executed (step 706).

In response to the execution of the command, a result is received (step 708). This result takes the form of an output record in these examples. The output record contains output data returned from a backend service. Further, this data also may be obtained from the command itself.

Thereafter, a determination is made as to whether to execute another command (step 710). A particular task may execute multiple commands depending on the evaluation of rules based on the response returned. If another command is not to be executed, the process terminates.

Turning back to step 710, if another command is to be executed, the process returns to step 704 as described above.

With reference next to FIG. 8, a flowchart of a process used for formatting data is depicted in accordance with a preferred embodiment of the present invention. The process illustrated in FIG. 8 may be implemented in a formatter, such as formatter 340 in FIG. 3.

The process begins by receiving an output record (step 800). An XML file describing the desired output is identified (step 802). Output data is generated in the desired format (step 804). The data is stored (step 806) and the process terminates thereafter.

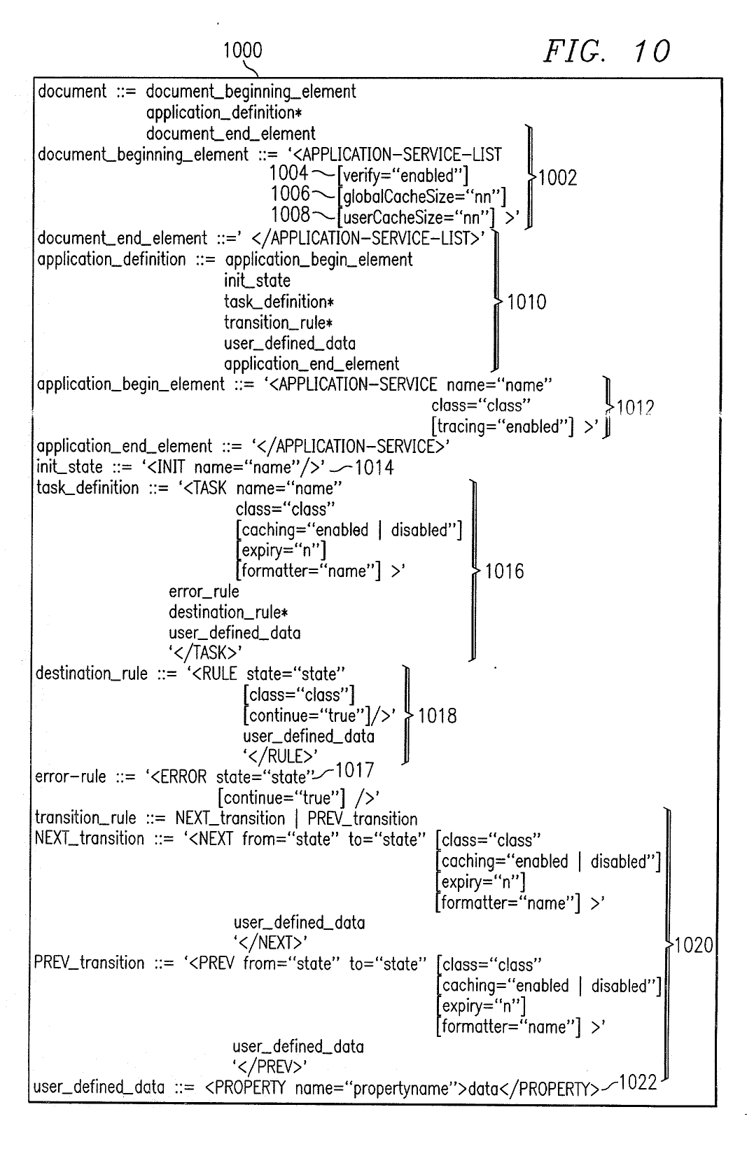

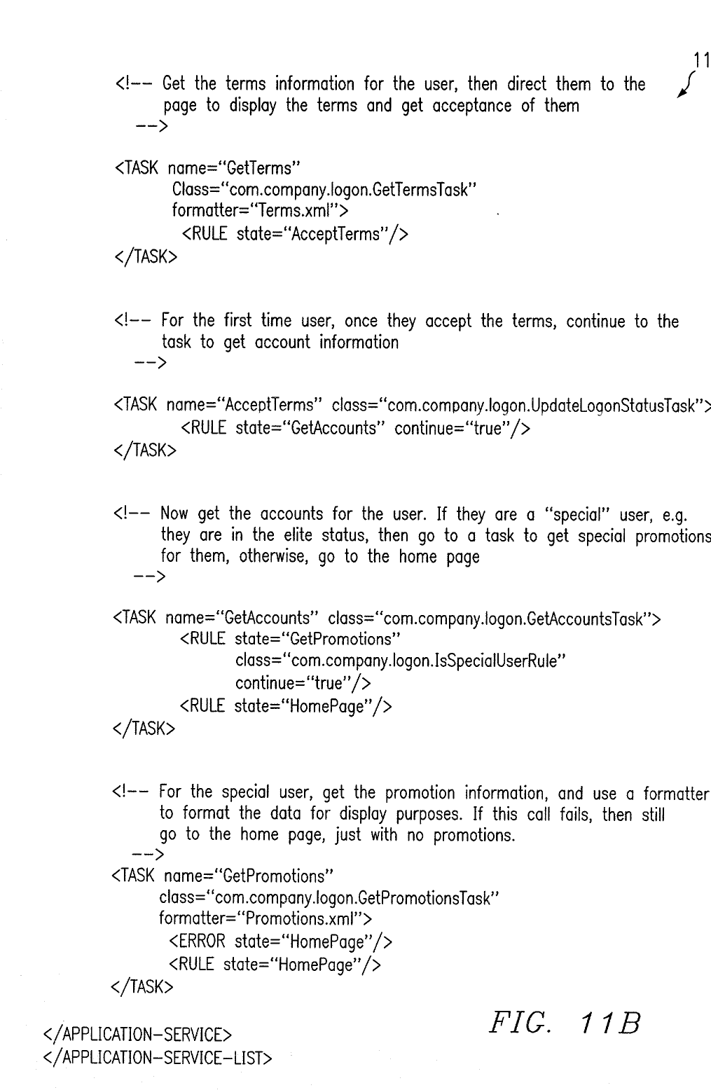

Turning next to FIG. 9, a flowchart of a process used for modeling a business process is depicted in accordance with a preferred embodiment of the present invention. The process begins by creating a presentation controller that calls an application service (step 900). Next, a new application services definition is created or an existing application services definition is reused (step 902). Tasks and rules for a business process are written (step 904). An application service is created to use tasks and rules (step 906). By definition, a specific application service could be created for each business process. In these examples, only two application services implementations are present that have been created, since the application services share the same logic rules. Generally, the business processes can use one of the already created application services as the implementation class. However, for each business process, they do need to create a new application service definition, such as those described in FIGS. 11A-11B.

Then, a determination is made as to whether there are more application services definitions (step 908). If there are not more application services definitions, the application services are tested (step 910) and the process terminates thereafter.

Turning again to step 908, if there are more application services definitions, the process returns to step 904 as described above.

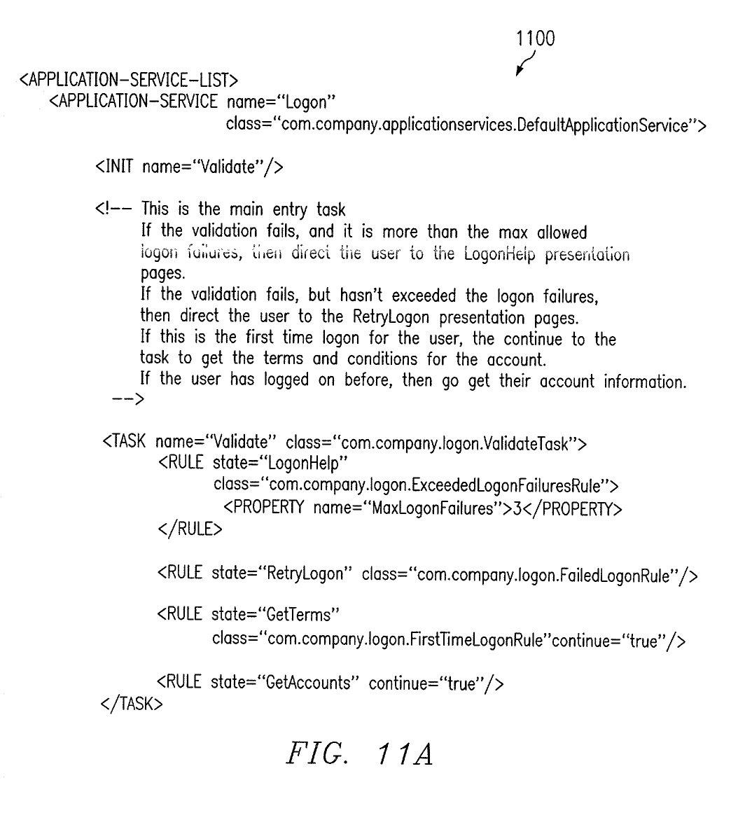

With reference now to FIG. 10, a diagram illustrating a data structure of a business process application model is depicted in accordance with a preferred embodiment of the present invention. Data structure 1000 is in the form of an XML file and encodes data defining a business application. Data structure 1000 externalizes the tasks or steps of a business process from the actual code that implements the steps. In particular, FIG. 10 specifies XML grammar for specifying a list of application services. This definition defines a business process state machine that includes states associated with tasks, actions, and transition rules. Actions are synonymous with task names, and are used to select the appropriate task for execution.

In section 1002 of data structure 1000, several attributes are present that control the overall actions of the application services. Attributes are provided to verify the application service definitions, and set the maximum number of elements permitted in the global and per-user caches.

If verify is enabled in line 1004, all referenced classes are loaded and instantiated when the definition is first loaded. If verify is disabled (or non-existent), errors in loading the referenced classes are not detected until an attempt to use the application is made. Verify can be used during development to help identify problems relating to loading the required classes. Once the problems have been corrected, verify may be disabled to improve startup time. The testing exit criteria and processes should ensure the XML files have been properly verified.

Options globalCacheSize and userCacheSize in lines 1006 and 1008 are also provided to set the maximum size of the global and user cache objects, such as those described above. Global cache objects contain immutable or context data, such as a list of states. A list of states does not change depending upon a user and such a list may be used by multiple users. The data in this type of cache is shared by all processes. User cache objects contain data specific to a particular user but is not likely or expected to change while the user is accessing the system.

Default values are used if these attributes are omitted or are specified incorrectly. The units used for the globalCacheSize and userCacheSize attributes are the number of elements.

In section 1010, an application definition is present. During the load process, the application services manager obtains the configuration information and transforms that information into an internal representation used to access and execute the application service.

Each application service is defined by specifying an initial task name, one or more task definitions, and zero or more navigation (“PREV” and “NEXT”) rules. Any XML elements specified that are not defined are treated as user defined properties and are available to the application service during its execution.

In these examples, each application service uses a unique name. The name space is not explicitly hierarchical although a dotted naming convention could be used, such as name=“Bank.GetRatesAppService”.

Section 1012 provides a name and a class for an application service. The name attribute is the identifier used when a user program requests a specific application service definition. The class attribute defines the implementation of the class for the application service. The tracing attribute in section 1012 provides an indication to the application service that it should create trace messages during the execution of the application service. The tracing attribute is optional.

Line 1014 in data structure 1000 includes an element used to define the name of the first task to be executed. This task is not automatically executed when an application service is instantiated, but when the first execute method is invoked on the application service, if a caller requests a specific task to be executed, the task identified in line 1014 may not be executed.

Next, section 1016, in data structure 1000 includes a task definition. The task definition in this section permits specification of a task name (name), an implementation class (class), caching parameters (caching and expiry), and formatting (formatter). In these examples, the caching and formatting parameters are optional. In addition, the task definition contains one or more rule objects that are evaluated after task execution. In addition, the task may contain an error rule that indicates the action to take if the execution of the task completes unsuccessfully. In addition, any elements defined within the task that are not specified in the syntax are treated as user defined properties.

The caching attribute is an indicator to the task as to whether the task is allowed to cache the response data. The task implementation is not required to cache data, even if the caching attribute is set to enabled. If caching is enabled for the task, the expiry attribute defines how long (in seconds) the data remains valid.

If the formatter attribute is specified, this attribute contains the name of the XML file that contains the mapping to be applied to the response data before it is returned to the caller.

Task names should correspond to the action that is passed with the request. When the task is executed, an instance of the class is created and executed. If the execution of the task completes unsuccessfully and an error rule exists, the error rule will be followed to determine the next state. A continuation rule may or may not be specified. If the execution of the task completes unsuccessfully and no error rule exists, the application service will return immediately. After execution of the task in which it completes successfully, the rule objects are processed in the definition order to determine the next state. When a rule evaluates to true, further rule evaluation stops, and the destination state for that rule is the new state of the application service. If no rules evaluate to true, the application service remains in the same state.

The error rule definition in line 1017 permits specification of the next state that is to be used if a task completes unsuccessfully. Only one error rule is permitted per task definition in these examples. If the error rule is specified, the next state is based on the specified state, and the task unsuccessful flag is set to indicate success. If the continuation is specifed, the next task will be automatically executed.

Section 1018 includes a rule definition. In this section, the rule definition permits specification of the destination state (state), evaluation class (class), and continuation rules (continue). The evaluation class and continuation rules are optional. If the class attribute is omitted, the rule always evaluates to true, and the new state is the specified state. The continuation rule permits automatic execution of the next task specified by the state. The continuation rule is only applied if the rule evaluates to true. Any elements not defined in the syntax are treated as user defined properties and are made available to the rule class during execution.

Section 1016 includes an error rule definition. In this section, the rule definition permits specification of the destination state (state) and continuation rules (continue). The continuation rule is optional. The continuation rule permits automatic execution of the next task specified by the state. The continuation rule is only applied if the error rule is used because of a failure.

The destination state value should correspond with an identifier used by presentation services to select the next group of pages to flow through. The state keyword “DONE” can be used as an indicator of no more work to be accomplished by the application service.

Next in section 1020, examples of transition rules are presented. The transition rules are specified by the “PREV” and “NEXT” elements. These are special tasks where the current state is used as a basis for determining the next state. The “PREV” and “NEXT” elements specify the current state (from), the destination state (to), and optionally a class name (class), formatting (formatter), and caching parameters (caching and expiry). If a class name is specified, and the transition rule is selected, the task is executed before moving to the new state. These rules are used when presentation services invokes the application service with a “NEXT” or “PREV” task ID. Based on the internal application service state (i.e. the state of the business process), the appropriate task is invoked.

User defined data in line 1022 is data that needs to be available to the tasks or rules, but which needs to be externalized from the code. While the main use is generally a key/value pair specified by the propertyname and data. Because this is an XML definition, the XML contents of the PROPERTY would be made available to the task or rule.

Turning next to FIGS. 11A and 11B, diagrams illustrating an example application service with tasks and rules are depicted in accordance with a preferred embodiment of the present invention. Code 1100 is an example of a portion of a website logon procedure. This code is located in an XML definition.

In FIGS. 11A and 11B, the presentation services layer (specifically, the presentation controller 303 or 403) calls the Logon application service when a user submits their user name and password. The initial task (Validate) attempts to validate the username and password for the user. The rules for the Validate task are executed in order until a rule evaluates to true. If the user enters a bad password, then if this entry is the third attempt, the first rule will be executed. Thereafter, the next task returned to presentation services will be LogonHelp indicating that the user needs help with logon.

The presentation services layer then acts upon this next state indication and displays an appropriate page. If the user has not exceeded the maximum number of bad logon attempts, then the next task returned to the presentation services will be RetryLogon indicating that the logon page should be redisplayed. If the username and password verify correctly, and this is a first time logon for the user, then the next rule transfers execution to the GetTerms task to retrieve the terms and conditions for the user's usage of the Web site. This task retrieves information from an enterprise system, formats the data appropriate using the Terms.xml, and returns a next task of AcceptTerms indicating that the user must accept the usage terms to be able to continue. Once the user accepts the terms for the accounts, the task AcceptTerms is executed to update the logon status reflecting acceptance of the terms, and continues on with retrieving the accounts (the GetAccounts task), and optionally the promotions.

A user that had logged on before immediately continues on to the GetAccounts task. The GetPromotions task illustrates the ERROR rule being used. If the GetPromotions task failed, the error path and the normal path converge to indicate the next task for the presentation services is HomePage.

As can be seen, the application service framework supports internalization in which control flow and configuration are placed into XML files outside of the Java code used to perform the tasks.

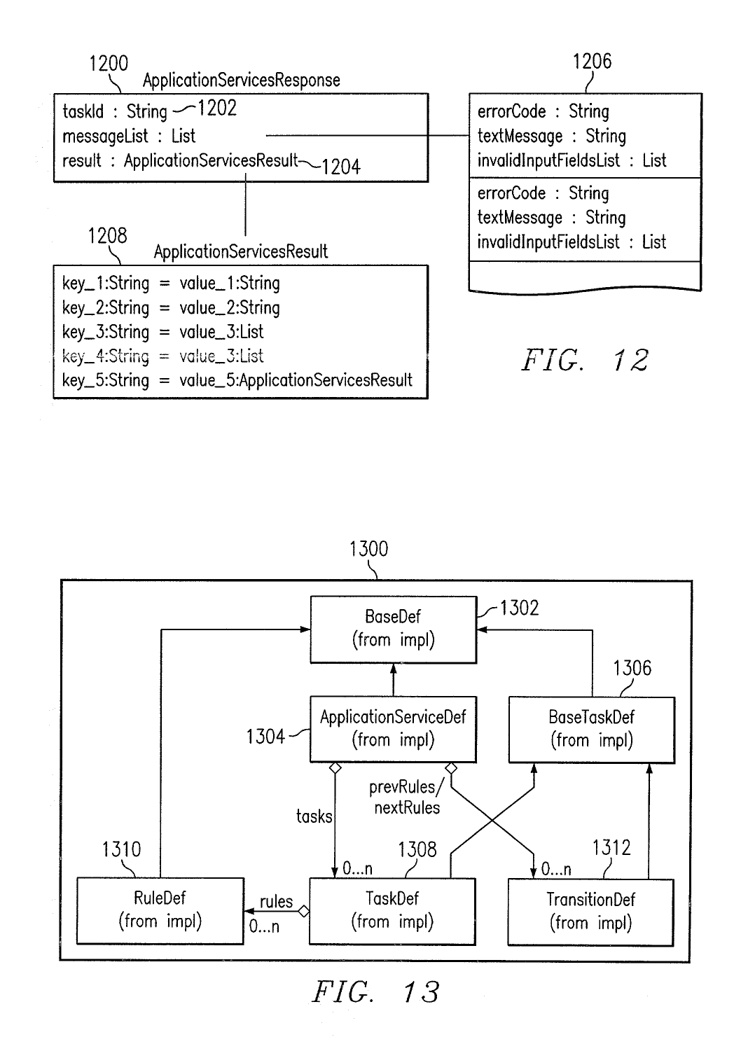

With reference next to FIG. 12, a diagram illustrating classes forming a response is depicted in accordance with a preferred embodiment of the present invention. The classes are used in a response, such as, for example, application services response object 430 in FIG. 4. The application services response class 1200 is a container for the various data to be returned from an application services request, such as application services request 410 in FIG. 4.

This class does not provide any additional semantics beyond that of a container. The attributes in the application services response are the next task identifier 1202, an application services result 1204, and a list of application services message objects 1206. Each request may return a list of application services objects. Each of these objects contains a return code and text message, which may have been obtained by a backend system.

The application services response is created by the application service and passed as a parameter to each of the tasks that are to be executed. The task adds attributes and/or messages to the provided response object.

Application services result class 1208 is a container for detailed response data. If the task specifies the name of a formatting pattern, then the data contained within an application services result is formatted based upon the application service definition. If the application service is targeted towards the presentation services implementation, the result most likely contains a single key, such as PsData and the value will be an object hierarchy containing the correctly formatted PsData objects. PsData is a class name also referred to as “presentation services data”. PsData is an object tree accessed using hierarchial names.

If no formatter is specified, then the data is returned using multiple key/value pairs. For each of the data items, the value may be a string, a list, or another application services result object (i.e. hash map). If a list type is returned, then all list elements are of the same type (e.g. string, or hash map containing all of the same keys).

Turning next to FIG. 13, a diagram illustrating definition classes used during the execution of an application service is depicted in accordance with a preferred embodiment of the present invention. In this example, definition object model 1300 includes BaseDef 1302, ApplicationServiceDef 1304, BaseTaskDef 1306, RuleDef 1310, TaskDef 1308, and TransitionDef 1312.

BaseDef class 1302 is an abstract class from which all of the other definition classes subclass. This base class defines the name and class attributes, as well as their accessor methods. In addition, BaseDef class 1302 defines the abstract methods, configure and verify. The configure method is used to configure each of the objects. The verify method is used to check the definition, generally relating to the ability to create an instance of the classes.

Next, ApplicationServiceDef 1304 class contains a hash map of the defined tasks for the application service. The keys used for the tasks hash map are the names of the actions/states. The objects referenced by the keys are TaskDef objects. ApplicationServiceDef class 1304 also contains hash maps containing the forward and backward transition rules. The current state is used as the key for locating the appropriate transition rule. The objects in the transition hash maps are TransitionDef objects. Hash maps are Java classes similar in implementation to the hash table class. A hash map is a set of keys each referencing a value contained within a table. A hash table has a similar structure.

BaseTaskDef class 1306 is an abstract class subclassed by both TaskDef class 1308 and TransitionDef class 1312. This abstract class provides a definition of the default attributes for a task (i.e. the caching attributes), as well as the base configure, verify, and get implementation methods used by the concrete subclasses.

TaskDef class 1308 contains the definition of the task as well as the rules used to determine the next state. ApplicationServicesDef class 1304 uses the action associated with the task as a key. The rules are stored in an ArrayList as RuleDef objects and are checked in order until a rule evaluates to true. If no rule evaluates to true, the task state remains unchanged.

RuleDef class 1310 defines the next state to be selected if the evaluation rule evaluates to true. TransitionDef class 1312 defines the next (or previous) state and possible execution class for the state transition. The originating state is not maintained inside the TransitionDef since it is used as a key for locating the TransitionDef in either the forward or backward transition maps.

The application services response object contains the name of the executed task and the name of the next task. The presentation services controller can make use of one or both of these pieces of information to determine which screens or Web pages need to be presented.

Through the different states that may occur based on user input received by application services, the control of screens or Web pages presented to a user by presentation services may be customized. For example, a customer logging into a Web site to purchase an automobile may be identified by the business through a user ID. Based on the identification of the customer, a credit rating or credit worthiness may be obtained. Based on the credit worthiness, the application services may tailor particular screens for presentation to the customer. For example, a customer with a high credit rating may be presented with Web pages identifying fifteen types of automobiles with configurable options that may be purchased by the customer based on a loan that may be made for the purchase. On the other hand, a customer with a low credit rating may only be provided with one or two options.

Customizations may be provided through the presentation services and the application services. In particular, presentation services may be configured to provide customizations, such as those based on the quality of service, such as a connection speed. Different instances of a task may be used depending on the type of connection or channel used. For example, different types of pages or screens may be presented depending on whether the customer is accessing the process using a personal computer, a personal digital assistant, or an automatic teller machine. Also, the options may change depending on the system resources used.

The mechanism of the present invention allows for this type of customization in a manner that allows for the business process to be separated from the presentation and collection of information. This architecture allows for easier modeling of business processes by applications for electronic commerce. This architecture allows for easier changes in business processed to be implemented. By changing an order of tasks or adding tasks in an application service, changes to presentation services are not required.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. An application service framework comprising:
a presentation service, wherein the presentation service presents a set of screens and generates input data from input obtained using the set of screens and presents output data using the set of screens;
an application service, wherein the application service receives the input data from the presentation service, generates a request to obtain the output data using the input data, and returns the output data to the presentation service; and
a backend service, wherein the backend service receives the requests from the application service and returns output data to the application service.

2. The application service framework of claim 1, wherein the application service formats the output data into a form useable by the presentation service prior to sending the output data to the presentation service.

3. The application service framework of claim 1, wheren the application service executes a set of tasks to generate the request.

4. An application server comprising:
a presentation services module, wherein the presentation services module uses a set of screens to receive input and presents received results;
an application services module, wherein the application services module executes a set of tasks for a process using the input to obtain output data, formats the output data into a form useable by the presentation services module to form the results, and sends the results for presentation in response to the state transition.

5. The application server of claim 4, wherein each task within the set of tasks comprises a portion of logic for a process.

6. The application server of claim 4, wherein a selected transition from one task to another task in the set of tasks results in a state in which the presentation services module obtains additional input using the set of screens.

7. The application server of claim 4, wherein only a portion of the set of screens is used to receive the input.

8. The application server of claim 6, wherein the input is a user identification and wherein screens within the set of screens used to obtain additional input are selected based on the user identification.

9. The application server of claim 4, wherein the at least one task makes a request to a connectivity services module to obtain the output data and further comprising:
the connectivity services module, wherein the connectivity module processes the request to generate the output data.

10. The method of claim 4, wherein a task within the set of tasks calls a backend service to generate the output data in response to the input.

11. The application server of claim 9, wherein the connectivity services module includes at least one of a database and a server.

12. The application server of claim 9, wherein the set of tasks form a state machine.

13. The application server of claim 12, wherein the state machine further includes states, actions, rules, and transitions.

14. The application server of claim 12, wherein the state machine is a business process state machine.

15. A method in a data processing system for providing a service, the method comprising:
receiving input data generated from input to at least one screen in a presentation services module;
executing a task from a plurality of tasks in response to receiving the input data, wherein the tasks use the input data to send a request for output data to a backend service;
obtaining output data from the backend service; and
formatting the output data into a form for presentation by the presentation services module.

16. The method of claim 15, wherein the plurality of tasks form a state machine.

17. The method of claim 15 further comprising:
repeating the executing step until all of the plurality of tasks have been executed.

18. The method of claim 17, wherein a transition from some of the plurality of tasks to others of the plurality of tasks includes returning state information to the presentation services module to obtain additional input data.

19. The method of claim 15, wherein the plurality of tasks form a business process.

20. The method of claim 15, wherein the business process is one of purchasing an automobile, accessing a checking account, or obtaining a loan.

21. A data processing system comprising:
a bus system;
a communications unit connected to the bus system;
a memory connected to the bus system, wherein the memory includes a set of instructions; and
a processing unit connected to the bus system, wherein the processing unit executes the set of instructions to receive input data generated from input to at least one screen in a presentation services module, execute a task from a plurality of tasks in response to receiving the input data in which the tasks use the input data to send a request for output data to a backend service, obtain output data from the backend service, and format the output data into a form for presentation by the presentation services module.

22. A computer program product in a computer readable medium for providing a service, the computer program product comprising:
first instructions for receiving input data generated from input to at least one screen in a presentation services module;
second instructions for executing a task from a plurality of tasks in response to receiving the input data, wherein the tasks use the input data to send a request for output data to a backend service;
third instructions for obtaining output data from the backend service; and
fourth instructions for formatting the output data into a form for presentation by the presentation services module.

23. A data processing system for providing a service, the data processing system comprising:
receiving means for receiving input data generated from input to at least one screen in a presentation services module;
executing means for executing a task from a plurality of tasks in response to receiving the input data, wherein the tasks use the input data to send a request for output data to a backend service;
obtaining means for obtaining output data from the backend service; and
formatting means for formatting the output data into a form for presentation by the presentation services module.

24. The data processing system of claim 23, wherein the plurality of tasks form a state machine.

25. The data processing system of claim 23 further comprising:
repeating means for repeating the executing step until all of the plurality of tasks have been executed.

26. The data processing system of claim 25, wherein a transition from some of the plurality of tasks to others of the plurality of tasks includes returning state information to the presentation services module to obtain additional input data.

27. The data processing system of claim 23, wherein the plurality of tasks form a business process.

28. The data processing system of claim 23, wherein the business process is one of purchasing an automobile, accessing a checking account, or obtaining a loan.
